(19) United States
(12) Patent Application Publication
(10) Pub. No.: US 2026/0030681 A1
(43) Pub. Date: Jan. 29, 2026

(54) PROTECTION SERVICE MANAGEMENT SYSTEM

(71) Applicant: State Farm Mutual Automobile Insurance Company, Bloomington, IL (US)

(72) Inventors: Brian Fields, Phoenix, AZ (US); Steve Amancha, Tempe, AZ (US); Ross Wheeler, Scottsdale, AZ (US); Lauren Mitchell, Phoenix, AZ (US); Tony Welcome, Mesa, AZ (US); April Morgan, Saint Louis, MO (US); Diana Sherwood, Scottsdale, AZ (US); Marc Sierra, Phoenix, AZ (US); Matt Megyese, Phoenix, AZ (US); James Lemieux, Phoenix, AZ (US)

(73) Assignee: State Farm Mutual Automobile Insurance Company, Bloomington, IL (US)

(21) Appl. No.: 18/915,000

(22) Filed: Oct. 14, 2024

Related U.S. Application Data
(60) Provisional application No. 63/675,183, filed on Jul. 24, 2024.
(60) Provisional application No. 63/696,741, filed on Sep. 19, 2024.

(51) Int. Cl. G06Q 40/04

(52) U.S. Cl. CPC G06Q 40/08

(57) ABSTRACT

A protection service management system may (1) detect a change in context information associated with a user having a protection service plan that protects an asset of the user, the context information being automatically determined without the user being required to manually provide the context information and including location information associated with the asset of the user; (2) determine a modification of the protection service plan of the user based upon the change in the context information; (3) transmit a prompt to a user device associate with the user, the prompt requesting approval of the modification; and/or (4) initiate the modification upon receiving approval of the modification via the user device.

### CROSS REFERENCE TO RELATED APPLICATIONS

This application claims priority to and the benefit of U.S. Provisional Patent Application No. 63/696,741, filed Sep. 19, 2024, and U.S. Provisional Patent No. 63/675,183, filed on Jul. 24, 2024, each of which is incorporated herein by reference in its entirety.

### FIELD OF THE INVENTION

The present disclosure generally relates to service management systems. More particularly, the present systems and methods relate to service management systems that allow for automatic notifications and/or updates of services associated with user assets based upon location and usage information associated with the user assets.

### BACKGROUND

Individuals may obtain protective services (e.g., insurance policies or endorsements) for a variety of assets. For example, individuals may wish to protect their homes, vehicles, businesses, personal property, etc. Protective services may provide coverage in case assets become damaged, stolen, or lost. Protective service may additionally provide coverage for various types of liability (e.g., a business liability policy, a personal liability umbrella policy).

However, conventional protective services may be limited in the flexibility provided to individuals who move from place to place. Conventional techniques may also have certain other ineffectiveness, inefficiencies, encumbrances, and/or other drawbacks as well.

### BRIEF SUMMARY

A protection service management computer system may be provided that (i) detects changes in context information associated with a user having a protection service plan, and (ii) determines and initiates various protection service plan modifications for the user based upon the changes context information. For instance, the modifications may be proposed to the user via a user interface that may be presented to the user, such as on a mobile device or other computing device, explaining the proposed modifications and allowing for the user to approve or deny the proposed modifications. Additionally or alternatively, some proposed modifications may be automatically initiated by the protection service management computer system.

In one aspect, a protection service management computer system may be provided. The protection service management computer system may include one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, generative AI tools (e.g., generative AI bots, APIs, models, etc.), and/or other electronic or electrical components, which may be in wired or wireless communication with one another and/or operate as input and/or output devices. For instance, the protection service management computer system may include one or more memory devices having instructions stored thereon that, when executed by one or more processors, cause the one or more processors to perform several operations, including (1) detecting a change in context information associated with a user having a protection service plan that protects an asset of the user, the context information (i) being automatically determined without the user being required to manually provide the context information, and (ii) including location information associated with the asset of the user; (2) determining a modification of the protection service plan of the user based upon the change in the context information; (3) transmitting a prompt to a user device associated with the user, the prompt requesting approval of the modification; and/or (4) initiating the modification upon receiving approval of the modification via the user device. The computer system may include additional, less, or alternate functionality, including that discussed elsewhere herein.

In another aspect, a computer-implemented method for performing dynamic context-based service plan modifications may be provided. The computer-implemented method may be implemented via one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, generative AI tools (e.g., generative AI bots, APIs, models, etc.), and/or other electronic or electrical components, which may be in wired or wireless communication with one another and/or operate as input and/or output devices. For instance, the computer-implemented method may include (1) detecting, using one or more processors and one or more computer-readable storage media having instructions stored thereon executable by the one or more processors, a change in context information associated with a user having a protection service plan that protects an asset, the context information including location information associated with the asset of the user; (2) determining, using the one or more processors, a proposed modification of the protection service plan of the user in response to detecting the change in the context information and without the user being required to request the proposed modification of the protection service plan; (3) providing, using the one or more processors, a prompt to a user device of the user in response to determining the proposed modification, the prompt indicating the proposed modification of the protection service plan and requesting approval; and/or (4) after user review, modification, and/or approval, initiating, using the one or more processors, the proposed modification in response to receiving an indication of approval from the device of the user. The method may include additional, less, or alternate functionality, including that discussed elsewhere.

In another aspect, a non-transitory computer-readable medium comprising instructions stored thereon that, when executed by one or more processors, cause the one or more processors to perform various functionality and operations. For instance, the functionality and operations may include (1) detecting a change in context information associated with a user having a nomadic protection service plan, the nomadic protection service plan protecting an asset of the user as the asset is moved between different service regions having one or more of different device requirements, different service availabilities, or different recommended services associated with the asset, the context information including location information associated with the asset of the user; (2) determining a modification of the nomadic protection service plan of the user based upon the change in the context information indicating that the asset has moved from a first service region to a second service region; (3) transmitting a prompt to a user device associated with the user, the prompt requesting approval of the modification; and/or (4) initiating the modification of the nomadic protection service plan upon receiving approval of the modification via the user device.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers indicate identical, functionally similar, and/or structurally similar elements.

There are shown in the drawings arrangements which are presently discussed, it being understood, however, that the present embodiments are not limited to the precise arrangements and are instrumentalities shown, wherein:

FIG. 1 is a block diagram of an exemplary protection service management computer system, according to some embodiments.

FIG. 2 is a block diagram of an exemplary protection service management system, according to some embodiments.

FIG. 3 is a flow diagram of an exemplary computer-implemented or computer-based process of performing dynamic context-based service plan modifications, according to some embodiments.

FIG. 4 is an exemplary asset summary page provided to a user, according to some embodiments.

FIG. 5 is an exemplary service plan summary page provided to a user, according to some embodiments.

The Figures depict preferred embodiments for purposes of illustration only. One skilled in the art will readily recognize from the following discussion that alternative embodiments of the systems and methods illustrated herein may be employed without departing from the principles of the present embodiments described herein.

### DETAILED DESCRIPTION

The present embodiments relate to, inter alia, a protection service management computer system that performs dynamic context-based service plan modifications for users. For instance, the dynamic context-based service plan modifications may include various required, optional, and/or recommend modifications to service plans (e.g., insurance coverage plans) determined or otherwise generated based upon various context information (e.g., location information, usage information, residence information) pertaining to the user and/or various assets covered by the user's service plan.

The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT bots, generative AI tools (e.g., generative AI bots, APIs, models, etc.), InstructGPT bots, Codex bots, Google Bard bots, and/or other electronic or electrical components, which may be in wired or wireless communication with one another. The computer system may include additional, less, or alternate functionality and/or operations, including that discussed elsewhere herein.

### Overview

Referring to the Figures, computer systems and computer-implemented methods for performing dynamic context-based service plan (e.g., maintenance plan, insurance plan, or other service plan) modifications may be provided. For example, the computer system may be configured to receive context information associated with a user having a service plan. The computer system may determine and initiate a variety of service plan modifications based upon the context information. For instance, different service regions may have different rules, regulations, available coverages, recommended coverages, and/or risk factors, such that different service plan features may be applicable in certain service regions and not in other service regions. Accordingly, in some embodiments, the computer systems and computer-implemented methods described herein may automatically initiate or otherwise implement the service plan modifications (e.g., upon user approval). Additionally or alternatively, the service plan modifications may be provided, presented, or outputted to a user (e.g., via a user interface) to allow for the user to selectively approve or deny proposed modifications. In some embodiments, the service plan modifications may be provided, presented, or otherwise outputted to the user in various other manners, such as audibly via a voice bot or chatbot, or visually or graphically via a computing device display, such as a mobile device, VR headset, AR glasses, a smart vehicle control console or display, or other computing devices, including those mentioned elsewhere herein.

Traditional insurance plans and policies have been region-based (e.g., state-based) and have been unable to account for or adequately cover nomadic individuals who live and/or travel for long periods of time in multiple states without having legal permanent addresses. These individuals may include, for instance, individuals living in their vehicles (e.g., vans, mobile homes, or recreational vehicles), individuals working remote at various rented or booked properties (e.g., extended-stay hotels, Airbnb rentals, Vrbo rentals), retirees, traveling professionals, gig workers, college students, individuals facing financial challenges, individuals caring for health needs in their families, individuals living alternative family lifestyles, dreamers, explorers, influencers, etc.

In these scenarios, residency requirements, tax implications, title information, and minimum coverages may not be accurately tracked and accounted for in the coverage policies for the individuals' situations. As such, the individuals may be out of compliance with state laws and minimum requirements and/or not obtaining the recommended coverages for their location and/or the location of their assets.

The computer systems and computer-implemented methods described herein allow users (e.g., customers) to obtain a dynamic context-based service plan (e.g., insurance coverage plan) that may be regularly updated (e.g., automatically and/or based upon user approval) to account for changing locations and other circumstances associated with the user and/or their protected assets. Instead of being tied to any particular physical address, the dynamic context-based service plan may be tied to a user nomad code (e.g., an alphanumeric code or index) that allows for the user to selectively activate, endorse, and/or deactivate various location-specific policies for their assets as the user's circumstances change. Accordingly, by tracking and monitoring context information pertaining to the user, the user's assets, and the user's active policies, the computer systems and computer-implemented methods described herein may ensure that the user's coverage is in compliance with local regulations, that the user is adequately covered (and/or has been made aware of any recommended coverages) for the location and situation they are in, and also avoid providing the user with coverages that they no longer need (e.g., thereby saving the user the costs of those unnecessary coverages). In some instances, the context information may include monitored location and/or usage information associated with various covered assets that allow for a dynamic, usage-based insurance policy to be provided to the user (e.g., by automatically prompting the user to update their policy coverages based on their use of their covered assets).

Beneficially, the computer systems and computer-implemented methods described herein may provide technical solutions to technical problems by combining and cross-correlating telematics data, location data, regulatory information, scenario-specific risk information, and/or a variety of additional context information from disparate sources to generate and initiate various service plan modifications in real-time or near real-time, as well as provide various insights related to how the service plan modifications may affect the user's compliance with various state laws, required coverage minimums, and/or recommended coverages, which have not been traditionally available. Further, by having the policies linked to a user nomad code, as opposed to a physical address, the user may retain the dynamic context-based policy plan as they move from place to place. Additionally, because the user does not need to apply for a new policy when they travel, the user can retain the same service plan and thereby retain longevity credits provided by the provider of the service plan.

### Exemplary Protection Service Management Computer System

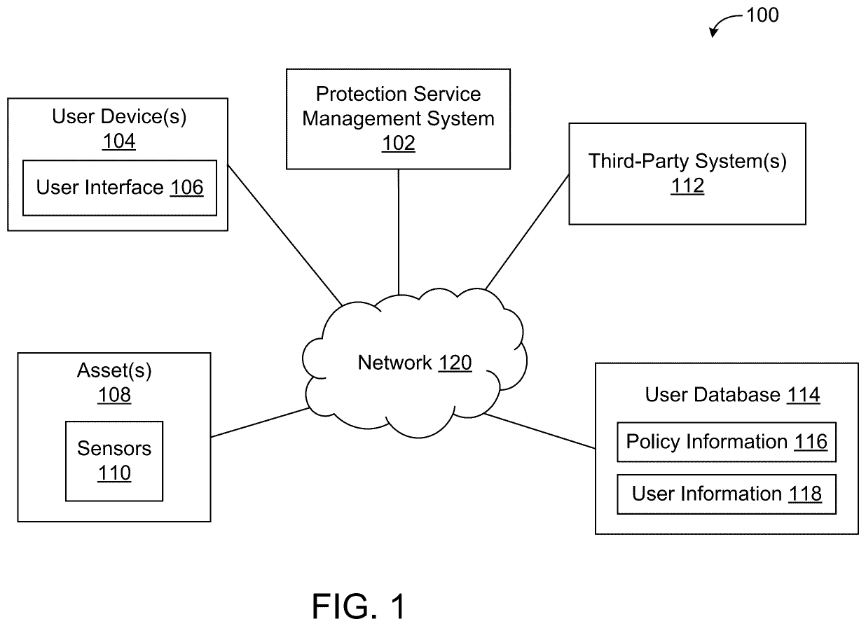

Referring to FIG. 1, a block diagram of an exemplary protection service management computer system, shown as protection service management computer system 100, is shown, according to some embodiments. The protection service management computer system 100 may include a protection service management computer system, shown as protection service management system 102, a user device 104 having a user interface 106, and at least one asset, shown as asset 108 having one or more sensors 110. The protection service management computer system 100 may also include one or more third-party systems 112 associated with various third-party entities. The protection service management computer system 100 may also include a user database 114 storing policy information 116 and user information 118. The components of the protection service management computer system 100 may be connected, in wired or wireless communication, via a network 120. It should be noted that the number and type of components shown is merely illustrative and, in some embodiments, implementations of the protection service management computer system 100 may have additional, fewer, and/or different components than those illustrated in FIG. 1, including those mentioned elsewhere herein.

In some embodiments, the protection service management system 102 may be associated with a provider (e.g., a company or an entity) that provides protective services (e.g., insurance) and/or various other services to a user or operator (e.g., a user or operator associated with the user device 104), a company or service provider (e.g., an entity associated with the third-party system 112), and/or over one or more assets (e.g., the asset 108, etc.), such as a vehicle (e.g., a car, a truck, a recreational vehicle (RV), an all-terrain vehicle (ATV), personal belongings, personal articles, etc.), real property (e.g., a house, a condominium, etc.), a business, etc.

As will be discussed in greater detail below, the protection service management system 102 may be configured to determine various required, optional, and/or recommended service plan modifications associated with various required, optional, and/or recommended services (e.g., insurance coverages and/or endorsements) for one or more assets (e.g., the asset 108, etc.) of the user based upon received context information associated with the user and/or the one or more assets. For instance, the protection service management system 102 may determine that a particular asset of the user has moved from a first service region (e.g., a first state) to a second service region (e.g., a second state) having different service characteristics (e.g., service requirements, service availabilities, recommended services, etc.). In some embodiments, the protection service management system 102 may then automatically modify (e.g., upon user approval) the user's service plan for the one or more assets based upon the different service characteristics in the second service region. In various embodiments, the protection service management system 102 may additionally or alternatively prompt or notify the user to approve or deny the modified service plan.

In some embodiments, the protection service management system 102 may be implemented using cloud computing services. In some embodiments, the protection service management system 102 may be implemented using one or more computing devices, for example, operating alone and/or in combination. In some embodiments, the protection service management system 102 may be implemented using computing architectures like multiple distributed servers, and/or similar computing devices and/or systems. In some embodiments, the protection service management system 102 may be another suitable computing system, for example, distributed across multiple systems or devices (e.g., which may be located within a single building or facility, or distributed across multiple different buildings or facilities), or within a single computer (e.g., one server, housing, etc.). All such implementations are contemplated herein.

As shown, the protection service management system 102 may be configured to communicate with the user device 104. The user device 104 may include one or more human-machine interfaces or client interfaces, shown as user interface 106 (e.g., a graphical user interface, a text-based computer interface, a client-facing web service, a web service that provides pages to a web client, etc.), for example for controlling, viewing, and/or otherwise interfacing with the protection service management system 102. The user device 104 may include a personal mobile computing device (e.g., a smart phone, a tablet, a mobile device, a wearable, smart glasses, a smart watch, etc.). The user device 104 may include a computer workstation, a client terminal, a remote or local interface, and/or any other user interface device. The user device 104 may be a stationary terminal (e.g., a desktop computer, a laptop computer, a tablet, or another suitable non-mobile device).

In some embodiments, information/data associated with the user device 104 may be communicated to the protection service management system 102. In some embodiments, the user device 104 itself may be configured to communicate information/data to the protection service management system 102. In some embodiments, a device coupled to the user device 104, a component implemented with the user device 104, an application or program housed and/or executed on the user device 104, and/or another suitable component associated with the user device 104 may be configured to communicate information/data to the protection service management system 102.

The protection service management system 102 may also be configured to receive information/data associated with the user device 104. For example, the user device 104 may (e.g., automatically, or in response to an input from a user or operator, etc.) communicate geolocation and/or telematics data (for instance, vehicle telematics data such as acceleration, braking, cornering, location, heading, speed, GPS, lane information, route, direction, driver, passenger, and/or other driving data associated with a vehicle) associated with the user device 104 to the protection service management system 102. For instance, the user device 104 may communicate information associated with a location of the user device 104, a speed and/or direction of movement of the user device 104, a starting/ending location of the user device 104 during a travel event, and/or other similar geolocation and/or telematics data. The user device 104 may communicate real-time and/or historic geolocation and/or telematics data associated with the user device 104 to the protection service management system 102.

In some embodiments, a user or operator may opt-in to sharing geolocation and/or telematics data with the protection service management system 102, such that the user device 104 communicates geolocation and/or telematics data to the protection service management system 102 at predetermined times (e.g., hourly, daily, weekly, etc.), in predetermined locations (e.g., in an identified geofenced location, for example when “at home” or “at work,” etc.), during use of predetermined applications, services, and/or interfaces associated with the user device 104 (e.g., a navigation/map application, a transportation or rental application, etc.), and/or other similar scenarios.

In some embodiments, the protection service management system 102 may be configured to receive information/data associated with the asset 108. For instance, the protection service management system 102 may receive location (e.g., geolocation) and/or telematics data associated with the asset 108. In some instances, the location and/or the telematics data may be captured via one or more sensors 110 and/or other devices associated with or otherwise integrated into the asset 108. For instance, the asset 108 may be a vehicle, and the sensors 110 may include driving monitoring sensors installed within the vehicle (e.g., provided by the company or entity associated with the protection service management system 102) and/or various native sensors of the vehicle (e.g., connected vehicle data sensors). In some instances, location data and/or various other context information associated with the asset 108 may be provided to the protection service management system 102 via a user input provided by the user using the user device 104 (e.g., via the user interface 106).

As shown, the protection service management system 102 may be configured to receive information/data associated with one or more third-party systems 112. In some embodiments, a third-party system 112 may be associated with a third-party regulatory authority managing one or more service regulations (e.g., insurance regulations), such as, for example, a state regulatory authority or a federal regulatory authority. In various embodiments, the protection service management system 102 may be configured to pull various regulatory information (e.g., regulatory requirements, regulatory service availabilities, etc.) from the third-party systems 112 for use in determining potential service plan modifications for users. In some embodiments, a third-party system 112 may be associated with a land management entity (e.g., a campground, the Bureau of Land Management, the National Park Service, a state park service, etc.) that allows for public camping or lodging. Accordingly, in certain embodiments, the protection service management system 102 may be configured to pull various land usage rules or regulations associated with public camping or lodging from the third-party systems 112.

As shown, protection service management system 102 may be configured to communicate with the user database 114. In certain implementations, the user database 114 may retrievably store information relating to one or more protection policies of the user (e.g., policy information 116) and/or information relating to one or more users and/or assets of the users (e.g., user information 118). In various embodiments, information/data associated with the user database 114 may be communicated to the protection service management system 102.

The policy information 116 may include data on types of policies. For example, policy information 116 may include, for each user, information on what types of policies the user has and details on the assets (e.g., the asset 108) covered by the policies (or endorsements). For instance, policies may be homeowner's policies, automotive or vehicle policies, health/medical policies, life policies, renter's policies, flight/travel insurance policies, lifestyle policies, personal articles or personal belongings policies, umbrella policies, parametric policies, business liability policies, various or related endorsements, etc.

In some instances, the policy information 116 may include an address, a size and/or an age of a house covered by a homeowner's policy, a make, model, and/or a vehicle identification number of a vehicle covered by an automotive policy, information associated with a covered business or company, previous claims filed for the one or more policies, etc. The policy information 116 may include more specific data regarding assets covered by a policy. For instance, the policy information 116 may include an age of certain components of a home. As an example, the policy information 116 may indicate that a home is 30 years old, but the roof of the home is 20 years old and the windows of the home are 10 years old. As an additional example, the policy information 116 may include information on a make and model of a vehicle, and may also include, for example, a number of miles on the vehicle.

In some instances, the policy information 116 may include a nomadic protection service plan (e.g., a comprehensive and dynamic service plan) associated with a user configured to be automatically and/or dynamically updated (e.g., upon user approval) in response to context information associated with the assets covered by the service plan. For example, the nomadic protection service plan may protect various assets of the user as the assets are moved between different service regions (e.g., different states) having different service requirements, different service availabilities, and/or different recommended services associated with the various assets. In these instances, the policy information 116 may further include a user nomad code associated with the service plan. As will be described below, the user nomad code may be generated by the protection service management system 102 and configured to allow for the service plan to remain open or otherwise active without being permanently tied to a physical address, thereby allowing for the user to freely move between different coverage areas (e.g., different states, municipalities, etc.) without needing to open new policies.

The user information 118 may include data on users that have policies associated with the provider. The user information 118 may include information relevant to policies and/or policy plans of the user. For example, the user information 118 may include an age of the user, a number of dependents of the user, driving habits of the user and/or dependents, and/or historical location data associated with the user and/or one or more assets of the user covered by the policies and/or the policy plans. The user information 118 may be information obtained by the protection service management system 102 when a user obtains one or more policies with the provider. In various embodiments, the protection service management system 102 may obtain user information 118 via a third-party system (e.g., third-party system 112). For instance, the protection service management system 102 may obtain user health data from a health and fitness application that may be relevant to a health policy of the user.

The user information 118 may also include information relating to an asset relevant to the user and/or a protection policy, but that is not itself covered by a policy. For instance, a user may own a home and have a homeowner's policy associated with the home. On the home's lot, the user may have a pool. The pool may not be an asset covered by the policy, but the user database 114 may receive information regarding the pool (e.g., that a pool is located in the yard of the home) because the pool is associated with the home covered by the homeowner's policy.

In some embodiments, the user information 118 and/or the policy information 116 may be collected and/or gathered via a user device (e.g., the user device 104). For instance, the user information 118 and/or the policy information 116 may include audiovisual information (e.g., captured via a microphone or camera of the user device 104, and/or captured via a mobile device, AR glasses, VR headset, voice bot, chatbot, wearable, or other computing devices, including those mentioned herein), for example audiovisual (including audio, visual, video, image, and/or graphical information, data, and sensor data) information and related data captured in real-time and/or historical audiovisual information and related data.

In some embodiments, the protection service management system 102 may be configured to receive additional information/data associated with the policy information 116 and/or the user information 118 of the user database 114. For example, the protection service management system 102 may receive location and/or telematics data associated with the user and relevant to the policy information 116 and/or the user information 118 of the user database 114 (e.g., from the user device 104, the asset 108, and/or the sensors 110 of the asset 108). For instance, the protection service management system 102 may receive location data for the user and/or location information for various assets covered under policies (e.g., a location of a house, a residential address of the user, a vehicle, an RV, etc.).

In some embodiments, some, or all, of the components of the protection service management system 102, the user device 104, the asset 108, the third-party systems 112, the user database 114, and/or the network 120 may be integrated within a single device or be distributed across multiple separate systems or devices. In some embodiments, various components of the protection service management system 102, the user device 104, the asset 108, the third-party system 112, the user database 114, and/or the network 120 may be components of a controller, a device controller, a field controller, a computer workstation, a client device, and/or another system or device that receives, processes, and/or communicates data from/to devices or other data sources.

### Exemplary Protection Service Management System

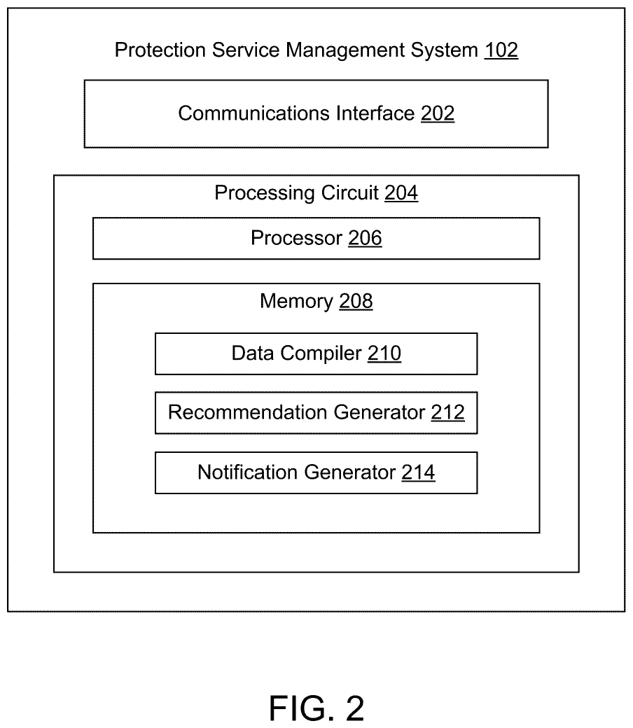

Referring to FIG. 2, the protection service management system 102 may include a communications interface 202 and a processing circuit 204 having a processor 206 and a memory 208. The communications interface 202 may include wired or wireless communications interfaces (e.g., jacks, antennas, transmitters, receivers, transceivers, wire terminals, etc.) for communicating data between the protection service management system 102 and external systems or devices (e.g., the user device 104, the asset 108, the third-party systems 112, the user database 114, etc.). In some embodiments, the communications interface 202 facilitates communications between the protection service management system 102 and one or more external applications and/or interfaces (e.g., the user interface 106), for example to allow a remote user or operator to control, monitor, and/or adjust components of the protection service management system 102.

Further, the communications interface 202 may be configured to communicate with external systems and/or devices using any of a variety of communications protocols (e.g., HTTP(S), WebSocket, CoAP, MQTT, etc.) and/or any of a variety of other protocols. Advantageously, the protection service management system 102 may obtain, ingest, and process data from any type of system or device, regardless of the communications protocol used by the system or device.

As shown, the protection service management system 102 may include the processing circuit 204 having the processor 206 and the memory 208. While shown as single components, it should be appreciated that the protection service management system 102 may include one or more processing circuits, including one or more processors and memory.

In some embodiments, the protection service management system 102 may include a plurality of processors, memories, interfaces, and/or other components distributed across multiple devices or systems, which are communicably coupled via a network (e.g., the network 120). For example, in a cloud-based or distributed implementation, the protection service management system 102 may include multiple discrete computing devices, each of which include a processor 206, memory 208, communications interface 202, and/or other components of the protection service management system 102. Tasks performed by the protection service management system 102 may be distributed across multiple systems or devices, which may be located within a single building or facility or distributed across multiple buildings or facilities. In other embodiments, the protection service management system 102 itself may be implemented within a single computer (e.g., one server, one housing, etc.). All such implementations are contemplated herein.

The processor 206 may be a general purpose or specific purpose processor, an application specific integrated circuit (ASIC), one or more field programmable gate arrays (FPGAs), a group of processing components, or other suitable processing components. The processor 206 may further be configured to execute computer code or instructions stored in the memory 208 or received from other computer readable media (e.g., USB or other local storage, network storage, a remote server, etc.).

The memory 208 may include one or more devices (e.g., memory units, memory devices, storage devices, etc.) for storing data and/or computer code for completing and/or facilitating the various processes described in the present disclosure. The memory 208 may include random access memory (RAM), read-only memory (ROM), hard drive storage, temporary storage, non-volatile memory, flash memory, optical memory, or any other suitable memory for storing software objects and/or computer instructions. In some embodiments, the memory 208 may include database components, object code components, script components, and/or any other type of information structure for supporting the various activities and information structures described in the present disclosure. The memory 208 may be communicably connected to the processor 206 via the processing circuit 204, and may include computer code for executing (e.g., by the processor 206) one or more processes described herein. When the processor 206 executes instructions stored in the memory 208, the processor 206 may configure the processing circuit 204 to complete such activities.

As shown, the protection service management system 102 (e.g., the memory 208) may include a data compiler 210, a recommendation generator 212, and a notification generator 214. The following paragraphs describe some of the general functions performed by each of the components 250-256 of the protection service management system 102. It should be noted that the number and type of components shown is merely illustrative and, in various implementations, implementations of the protection service management system 102 may have additional, fewer, and/or different components than those illustrated in FIG. 2.

In certain embodiments, the data compiler 210 may be configured to obtain input data, analyze the input data, and/or generate output data to be communicated to other components of the protection service management system 102 (e.g., the recommendation generator 212 and/or the notification generator 214). The data compiler 210 may obtain (e.g., receive, request, pull, etc.) various data associated with users, user assets (e.g., the asset 108), and/or user policies held by and/or provided to the user. In some instances, the data may be received from an external system or device (e.g., the user device 104, the asset 108, the sensors 110 of the asset 108, the third-party system 112, the user database 114, etc.), for example via the communications interface 202. For instance, the data compiler 210 may obtain various policy information 116 (e.g., information relating to policies held by the user) and/or user information 118 (e.g., personal information relating to the user).

In various embodiments, the data compiler 210 may additionally or alternatively obtain various context information (e.g., location information, usage information, travel plan information, etc.) from the user device 104, the asset 108, and/or the sensors 110. In certain embodiments, the data compiler 210 may additionally or alternatively obtain various regulatory information and/or other information (e.g., land usage rules) from one or more third-party systems 112 associated with one or more third parties and/or from the user database 114 (e.g., the policy information 116).

In some embodiments, the recommendation generator 212 may be configured to obtain input data, analyze the input data, and/or generate output data to be communicated to other components of the protection service management system 102. For example, the recommendation generator 212 may obtain (e.g., receive, request, pull, etc.) the various information collected or compiled by the data compiler 210 and analyze the information to generate various recommendations and/or to automatically initiate actions associated with generated recommendations, as described herein.

As will be described in detail below, the recommendation generator 212 may utilize the various information compiled by the data compiler 210 to generate various recommendations associated with one or more policies associated with various assets (e.g., the asset 108) of the user based upon monitored or otherwise received context information associated with the user and/or the assets. In some instances, the generated recommendations may be to ensure that the user is in compliance with regulations within a given service area (e.g., a given state). In some instances, the generated recommendations may be given based upon particular increased risks or other potentially likely scenarios in a given service area (e.g., hurricane protection in Florida, earthquake protection in California, etc.). In some instances, the generated recommendations may be given based on a monitored use (e.g., usage information) of one or more covered assets of the user to allow for usage-based insurance coverage. For example, the generated recommendations may include a recommendation for a vehicle coverage modification from comprehensive coverage to collision coverage, or vice versa, based on whether the vehicle is in use or stored for an extended period of time.

In some instances, the recommendation generator 212 may automatically initiate various actions associated with the generated recommendations. For example, in response to determining that a particular type of insurance is required for a given asset after the given asset has been moved to a new service area (e.g., a new state), the recommendation generator 212 may automatically update the user's service plan (e.g., insurance plan) or update the user's service plan with the user's review and approval of the proposed adjustment or modification, such as to include a new policy or endorsement to ensure that the user's coverage is in compliance with local rules and regulations. In some instances, the recommendation generator 212 may additionally or alternatively cause the notification generator 214 to generate and provide one or more notifications to the user, as will be discussed below.

It should be appreciated that the various recommendations, actions, notifications, etc., provided herein are provided as illustrative examples and are not meant to be limiting. In other embodiments, additionally or alternative recommendations, actions, notifications, etc., may be provided without departing from the scope of the present disclosure.

In various embodiments, the recommendation generator 212 may be configured to use historical user information, policy information, asset information, and/or other context information associated with users, policies, and/or assets to train a predictive model to generate recommendations and/or determine actions to automatically initiate. In some embodiments, the recommendation generator 212 may include one or more models and/or artificial intelligence models. For instance, the recommendation generator 212 may include one or more regression trees, deep neural networks, supervised learning model, unsupervised learning models, deep learning models, combined models, ChatGPT-based models, reinforcement models, nearest neighbor, generative adversarial (GANs), stable diffusers, generative artificial intelligence (GAI), transformers, or many other types of models, including combinations of the foregoing.

In various implementations, the machine learning models and/or artificial intelligence models may be trained to determine various service plan modifications based upon context information associated with users, policy plans, and/or users' assets. The machine learning models and/or artificial intelligence models may additionally be trained to generate and/or initiate various recommended actions based upon the context information including, but not limited to, activating, deactivating, endorsing, and/or un-endorsing various policies and/or causing the notification generator 214 to generate and transmit one or more notifications to the user (e.g., to the user device 104) regarding the generated recommended actions.

The notification generator 214 may generate various notifications and/or prompts for the user based upon the recommended actions and service plan modifications determined by the recommendation generator 212. For example, the notifications may include various information relevant to the user, the user's policies and/or policy plans, and/or recommended policy plan modifications. For instance, the notification generator 214 may generate the notification responsive to determining that a recommended service plan modification has been determined (e.g., from the recommendation generator 212).

In certain embodiments, the notification generator 214 may be further configured to communicate the notification to one or more devices, systems, and/or environments. For example, the notification generator 214 may be configured to communicate the notification to the user device 104 (e.g., via the communications interface 202), for example for display (e.g., via the user interface 106) or voice reproduction, such as in the case of a voice bot, chat bot, ChatGPT bot, generative AI tool (e.g., generative AI bot, API, model, etc.), etc. In various embodiments, a notification with a recommended service plan modification may be displayed on the user device, and the user may review, modify, accept, and/or approve the recommended service plan modification, such as by pressing an icon or button displayed on the user device (such as a mobile device) or via talking with a voice bot or chatbot.

It should be appreciated that, in some embodiments, various additional components of the protection service management computer system 100 (e.g., the user device 104, the asset 108, the third-party systems 112, the user database 114) may include similar components to those discussed above with respect to the protection service management system 102 (e.g., a communications interface similar to the communications interface 202, a processing circuit similar to the processing circuit 204, a processor similar to the processor 206, a memory similar to the memory 208).

### Exemplary Protection Service Management System Functionality

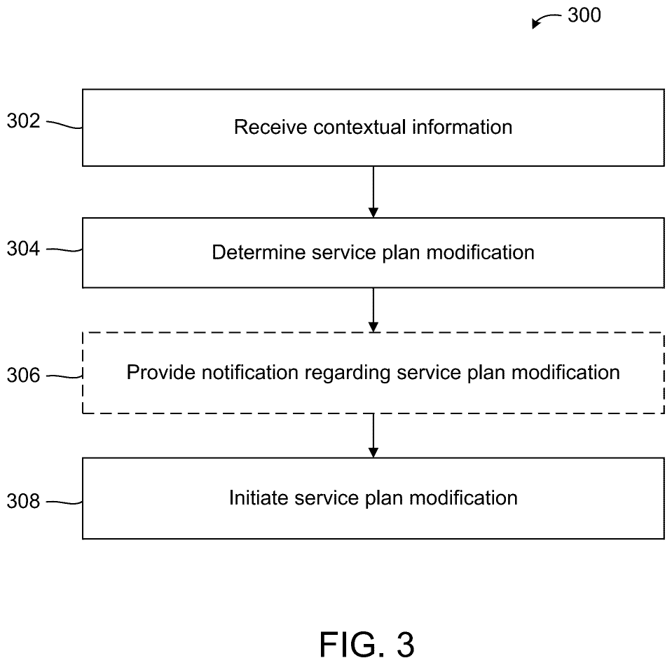

Referring now to FIG. 3, a computer-implemented or computer-based process, shown as process 300, for performing dynamic context-based service plan modifications for a nomadic protection service plan of a customer is shown, according to some embodiments. Computer-implemented process 300 may be implemented by any and/or all the components of the protection service management computer system 100 of FIGS. 1-2 (e.g., the processing circuit 204 of the protection service management system 102, etc.). It should be appreciated that any and/or all the process 300 may be implemented by other systems, devices, and/or components (e.g., components of the protection service management computer system 100, the protection service management system 102, etc.). Further, it should be appreciated that in some embodiments, process 300 may implemented using additional, different, and/or fewer operations, actions, and/or functionality.

Computer-implemented process 300 may include receiving context information associated with the user, the asset 108, and any relevant policies and/or policy plans (block 302), according to some embodiments. For example, in some instances, the user may have one or more policies and/or policy plans (e.g., a nomadic protection service plan) covering various assets (e.g., the asset 108). In some instances, the user and/or assets may have one or more profiles associated with them (e.g., a user profile, a driver profile, a vehicle profile, a home profile, etc.) that are configured to store or otherwise track various context information related to the user, the assets, and/or the associated policies or policy plans covering the assets. In certain embodiments, the profiles and the associated context information may be retrievably stored within the user database 114 (e.g., as user information 118).

In some embodiments, the context information may be received by the protection service management system 102 (e.g., the data compiler 210) from the user via one or more user inputs input into the user device 104 (e.g., via the user interface 106) and transmitted to the protection service management system 102 via the network 120. For example, in some instances, the user interface 106 may be generated as part of an application provided to the user device 104 by the protection service management system 102 (e.g., via the network 120) to enable the dynamic context-based service plans described herein. Accordingly, the user and/or a representative of the user (e.g., a service plan agent) may be prompted to enter a variety of information pertaining to the user and/or the user's assets to allow for the various service plan modifications described herein. In some instances, the protection service management system 102 may offer one or more incentives for signing up for a dynamic context-based service plan program associated with the application (e.g., discounted rates, rewards). In some instances, the user and/or the representative may be prompted on an ongoing or continual basis (e.g., daily, weekly, monthly) to provide up-to-date information pertaining to the user and/or the user's assets.

In various embodiments, the user input information may include user information, such as, for example, a primary user residence address (if the user has one), one or more phone numbers associated with the user, one or more email addresses associated with the user, one or more payment card numbers (e.g., debit card numbers, credit card numbers), one or more user locations (e.g., a current user location, previous user locations, expected future user locations), user travel plans (e.g., travel destinations, planned travel routes, travel itineraries), user tax-filing information (e.g., user tax filing states), user residence information (e.g., location information for where the user is currently residing or sleeping, how long the user is planning to stay in that location), other user survey data, etc.

The user input information may additionally or alternatively include various asset information. For instance, if the asset (e.g., the asset 108) is a vehicle, the asset information may include a vehicle location, a vehicle state (e.g., the vehicle is temporarily parked, the vehicle is being driven, the vehicle is being towed, the vehicle is being stored), vehicle scenario information (e.g., whether the vehicle is being towed in a trailer or via a front-wheel towing connection; whether the car is being used as a living space; whether the vehicle is parked at a repair shop, a storage unit, in a designated parking spot, or in a public parking spot; how long will the vehicle be parked where it is parked), vehicle registration information (e.g., what registrations or tags the vehicle has been registered for, renewal data, state restrictions), vehicle driver information (e.g., a list of drivers of the vehicle), vehicle owner information (e.g., a list of owners of the vehicle), financing information (e.g., loan information, loan-based coverage requirements), etc. If the asset (e.g., the asset 108) is a property, the asset information may include a property location (e.g., an address), indications of various tangible property associated with or maintained on the property, an occupancy status associated with the asset (e.g., whether the property is the user's primary address, whether the user owns or rents the property, etc.).

The user input information may additionally or alternatively include various policy information. For example, the user may hold one or more policies, endorsements, and/or policy plans with the provider associated with the protection service management system 102 and covering one or more assets (e.g., the asset 108). Accordingly, the policy information may include indications of which assets are covered by which policies, the types of coverages provided (e.g., homeowners, business liability, health), whether a given policy or endorsement is active or suspended, as well as relevant policy starting and/or termination dates.

In certain embodiments, the context information may additionally or alternatively be received by the protection service management system 102 (e.g., the data compiler 210) automatically as part of ongoing or otherwise continuous or periodic (e.g., hourly, daily, weekly, monthly) monitoring or tracking of one or more devices. For instance, the protection service management system 102 may continuously or periodically monitor or track various telematics data and/or other data associated with the user device 104, devices associated with the asset 108 (e.g., the sensors 110), or any other relevant device that may be used to monitor context information about the user and/or the asset 108.

Additionally or alternatively, as part of signing up for or otherwise receiving and installing the application provided to the user device 104 by the protection service management system 102, the user may approve or accept continuous monitoring of the user device 104 and/or devices associated with the asset 108 to allow for the dynamic context-based service plan modification described herein. Accordingly, in some instances, the context information and changes to the context information may be determined automatically without the user being required to manually provide the context information (e.g., via user input). In some instances, the user may additionally manually provide a portion of the context information (e.g., the user may provide intended travel information associated with an upcoming trip, an indication that the user has changed locations, an indication that the user has sold or bought an asset, etc.), such that the changes to the context information may be determined, in part, in response to a user input.

The telematics data may include, for example, location information (e.g., global positioning system (GPS) information), vehicle telematics information (e.g., vehicle data associated with acceleration, braking, cornering, location, heading, speed, GPS, lane information, route, direction, driver, passenger, and/or other driving data associated with the vehicle), or any other relevant telematics data. In certain embodiments, the location and/or vehicle telematics information may be utilized by the protection service management system 102 to infer various secondary information (e.g., whether the vehicle is parked within a parking lot, how long the vehicle has been parked, how many miles the vehicle has driven in a particular state or other service region, how many miles the vehicle has driven per day, what time of day the vehicle is being driven, driving habits of the user, etc.).

Other data associated with the user, assets, and/or policies that may be monitored or tracked may include, for example, security camera footage, audio recordings, virtual private network (VPN) connectivity information, hotspot information, credit/debit card purchase data, travel data (e.g., gas station purchases, flight check-ins, etc.). In some instances, some of these additional data sources may be utilized to confirm telematics data. For example, credit/debit card purchase data can be used to confirm that the user is in a location matching the location data associated with the user device 104.

It will be appreciated that the computer systems and computer-implemented methods described herein may be applied to a variety of users having differing types of assets covered by various protective service plans (e.g., insurance plans). Accordingly, the various types of context information described above (e.g., the user input information and the automatically monitored information) are provided as examples and are in no way meant to be limiting.

In some instances, users utilizing the dynamic context-based service plan described herein may not have a permanent home address. That is, the users may live a nomadic lifestyle in which they travel from place to place around the country throughout the year. In these instances, protection service management system 102 may generate a user nomad code (e.g., a user-specific code or index), store the user nomad code within the user database 114, and use the user nomad code to link or otherwise associate the user with each policy, endorsement, and/or policy plan held by the user and associated with the user's assets. Accordingly, as the user travels from state to state or service region to service region, the user does not need to open new policies tied to new physical addresses. Instead, one user nomad code may be tied to a plurality of selectively activatable policies and endorsements that span across multiple assets and service regions. The user can additionally add, pre-approve, endorse, and/or remove assets to and/or from the list of assets covered within each state, as desired. Accordingly, as will be described below, the user or the protection service management system 102 may simply activate and/or deactivate policies and endorsements in different states as the user travels, such as with user pre-approval and authorization, or the system 102 may communicate with the user device to receive user authorization or approval via the user device to activate and/or deactivate one or more policies, one or more endorsements, policy modifications or adjustments, coverage modifications or adjustments, and/or the like.

In some instances, the user nomad code may be an alphanumeric code (e.g., a nomadic policy number). In some other instances, the user nomad code may be a created address that is associated with nomadic user policies. In either case, the user nomad code allows for the user to retain a single policy number or code that may be carried for the user's entire life, in all locations (e.g., as the user moves from state to state or region to region) and used for all types of coverage (e.g., personal liability umbrella policies, personal property, auto liability coverage, etc.) and for a variety of asset types (e.g., homes rented or occupied by the user; vehicles owned, rented, subscribed to, borrowed, or leased by the user; personal articles or belongings; etc.) via selective activations and/or endorsements.

Computer-implemented process 300 may further include determining and/or generating one or more proposed service plan modifications based upon the context information (block 304), according to some embodiments. For example, the various context information received by the protection service management system 102 (e.g., the data compiler 210) may then be utilized (e.g., by the recommendation generator 212) to determine whether, based upon the context information, there are any required, optional, and/or recommended modifications to any of the user's policies, endorsements, and/or policy plans. In some instances, the service plan modifications may be determined automatically without the user being required to request the service plan modifications (e.g., via a user input). That is, the protection service management system 102 may continuously (e.g., in real-time, hourly, daily, weekly) determine various service plan modifications to initiate automatically or to propose (e.g., via a notification delivered to the user device 104) to the user for approval.

In some embodiments, the service plan modifications may be determined and/or generated by the protection service management system 102 (e.g., the recommendation generator 212) based upon the context information and/or other information relevant to the asset 108 and/or one or more policies associated with the asset 108 using one or more machine learning and/or artificial intelligence algorithms. For instance, the one or more machine learning and/or artificial intelligence algorithms may be trained to determine and/or generate service plan modifications based upon historical and/or continuously updated training information indicating service plan modifications taken by other users in similar scenarios, how those service plan modifications affected the users' asset coverage and/or compliance with local regulatory rules, how those service plan modifications affected the users' policy costs, and/or how those service plan modifications affected various other goals or preferences of users that are deemed relevant to proposing service plan modifications.

Accordingly, the protection service management system 102 (e.g., the recommendation generator 212) may receive the various context information and determine any required, optional, and/or recommended services for each of the user's assets based upon, for example, the context information (e.g., user information, asset location, asset usage information), available policies for a given area and asset type, locally applicable coverage requirements (e.g., local, state, or federal limits, ordinances, laws, etc.), user preferences (e.g., comprehensive coverage, cheapest coverage option), regional risk factors (e.g., increased crime rates in the area, severe weather risks, etc.) and/or any other relevant considerations.

In some instances, certain service regions (e.g., states) may have minimum required coverages. Accordingly, the protection service management system 102 may determine that a particular policy needs to be modified to increase the coverage level based upon the underlying asset (e.g., the asset 108) moving from a first service region having a first minimum level of coverage to a second service region having a second minimum level of coverage that is higher than the first minimum level of coverage. In some instances, these minimum required coverages may only apply after a given user or asset has been located within the corresponding service region for a predetermined amount of time (e.g., six months, nine months, a year) based upon the regulatory rules of the service region. As such, in these instances, the protection service management system 102 may only determine that the policy needs to be modified once the asset has been in the new location for the predetermined amount of time.

In various embodiments, the system 102 may send proposed modifications to a user device such that the user may review, adjust, modify, and/or approve the proposed modifications. Additionally or alternatively, the user may selectively pre-approve various modifications, such as if the user intends to spend half the year in Florida and half the year in Montana, or otherwise know their intended travel schedule well in advance.

Similarly, in some service regions, there may be optional coverage that are required to be offered to users (e.g., the provider of the protection service management system 102 is required by regulation or statute to offer these optional coverages). Additionally, there may be optional coverages available in certain service regions that are not available in other service regions (e.g., in-house employee worker's compensation liability coverage, sink-hole coverage for mining areas, no-fault vehicle liability coverage). Accordingly, in some instances, the protection service management system 102 may additionally determine and/or generate a variety of optional modifications for the user to adjust, modify, approve, and/or deny, as discussed below.

Additionally, some service regions may be more prone to certain types of events (e.g., hurricanes, floods, earthquakes, wildfires, sink holes, mud slides, crime). Accordingly, in some instances, the protection service management system 102 may further determine and/or generate a variety of recommended modifications (e.g., adding or removing hurricane, flood, earthquake, wildfire, sink hole, mud slide, and/or crime coverage) based upon the user and/or assets changing locations for the user to modify, adjust, approve, and/or deny, as discussed below.

Computer-implemented process 300 may further include providing a notification to the user regarding the one or more service plan modifications (block 306), according to some embodiments. In some instances, the protection service management system 102 (e.g., the notification generator 214) may generate and provide a notification or prompt to the user (e.g., the user device 104) explaining the proposed modifications and prompting the user to view, approve, adjust, modify, and/or deny the various required, optional, and/or recommend modifications. In certain embodiments, the user may further be prompted to allow for auto-initiation of future recommended service plan modifications. In some instances, the notification or prompt may be provided from the protection service management system 102 to the user device 104 via a user interface (e.g., the user interface 106). In some other instances, the notification or prompt may be provided via a text message, an email, a push notification, voice bot, chatbot, etc.

Computer-implemented process 300 may further include initiating the one or more service plan modifications (block 308), according to some embodiments. In some embodiments, the protection service management system 102 may automatically initiate the service plan modifications, such as with user pre-approval. For example, the protection service management system 102 may automatically enable, append, endorse, or otherwise activate or deactivate policies based upon the context information and determined service plan modifications (again such as with user pre-approval).

In various embodiments, the protection service management system 102 may automatically initiate (e.g., upon user approval) any determined required modifications needed for the user to remain compliant with local regulations (e.g., upon determining that the user and/or asset has remained within a new state for long enough to trigger a new coverage requirement). Similarly, the protection service management system 102 may automatically, or with user approval and review, deactivate or suspend any coverages, policies, and/or endorsements that are determined to no longer be available to the user. In some instances, if the user has given approval for automatic recommended service plan modifications, the protection service management system 102 may further automatically initiate any determined recommended modifications based upon the context information and any relevant preferences provided by the user (e.g., minimize cost, maximize protection). In these instances, the user may be notified of the automated modifications when they are made, such that the user can retroactively undo the modifications if they wish. In either case, the automatic, or user approved, initiation of the various service plan modifications may be implemented in real-time or near real-time based upon the monitored context information pertaining to the user and/or the user's assets.

In some other instances, the protection service management system 102 may enable, append, endorse, or otherwise activate or deactivate policies in response to user input or selections. For example, in response to the notification or prompt provided to the user (block 306), the user may select (e.g., via the user interface 106 on the user device 104) to adjust, modify, approve, endorse, or deny any service plan modifications.

### Exemplary Service Plan Modification User Interfaces

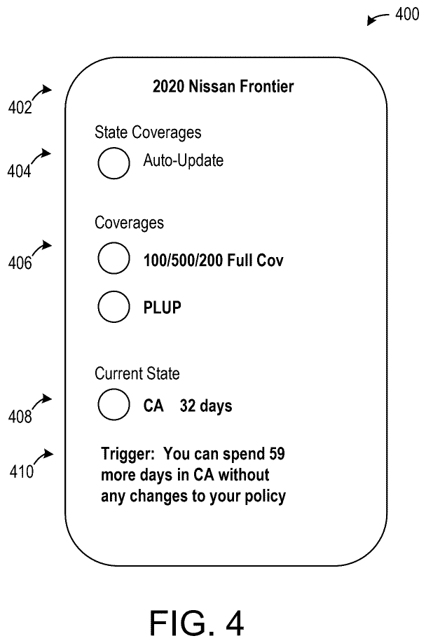

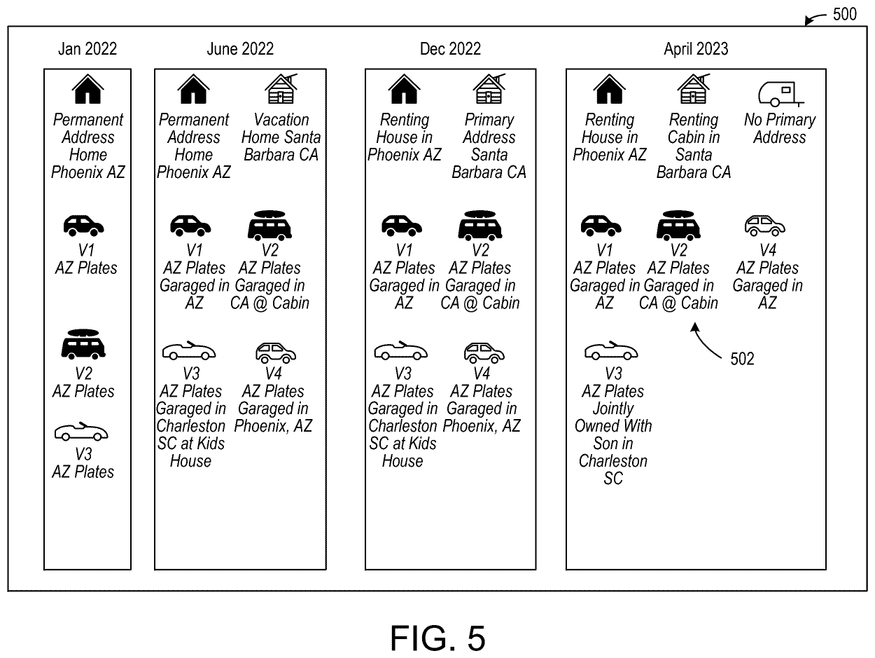

Referring now to FIGS. 4 and 5, an asset summary page (e.g., asset summary page 400) and a service plan summary page (e.g., service plan summary page 500) of an application for dynamic context-based service plan modifications are shown, according to some embodiments. The application may be accessible on any suitable electronic device, such as a mobile phone, tablet, smart home device, watch, or any other computing device. For instance, the application may be accessible on any of the protection service management system 102, the user device 104, and/or a user interface of the asset 108 (e.g., an interactive screen interface of a vehicle). The application enables a user (e.g., a policy holder or a regional or virtual agent of the policy holder) to, among other things, receive notifications and prompts associated with dynamic context-based service plan modifications, approve or deny those modifications, and/or review, adjust, and/or modify existing coverages associated with various assets of the user (e.g., the asset 108).

The asset summary page 400 shown in FIG. 4 is an example modification notification user interface that may be provided to the user (e.g., via the user interface 106 of the user device 104). As illustrated, the asset summary page 400 includes an asset identification 402 that provides the user with an identification of the asset covered by a given policy or policy plan being reviewed via the asset summary page 400. It should be appreciated that, while the asset identification 402 of the asset summary page 400 of FIG. 4 shows a vehicle (“2020 Nissan Frontier”), the asset summary page 400 or a similar page may be generated and provided for various other types of assets and/or policies (e.g., homes, personal, business).

The asset summary page 400 further includes an auto-update activation indicator 404 that provides the user with an indication of whether the user has activated or approved (or pre-approved or pre-activated) the dynamic context-based service plan modifications described herein. In some instances, the auto-update activation indicator 404 may be selectable on the asset summary page 400 (e.g., via the user interface 106 of the user device 104) to allow for the user to quickly activate or deactivate auto-updates to their coverage. Furthermore, upon clicking on or otherwise interacting with the auto-update activation indicator 404, the user may be able to activate auto-updates for some types of modifications (e.g., required modifications to remain in compliance with local regulations) while still requiring approval for other types of modifications (e.g., recommended modifications that are not required to remain in compliance with local regulations). In some instances, if the user has not yet activated or approved the dynamic context-based service plan modifications, the user may additionally be provided with a cost comparison between the user's current coverage and premium cost, and an estimated dynamic coverage and associated premium cost (e.g., based upon historical context information associated with the user).

In some instances, the asset summary page 400 further includes various coverage indicators 406 that provide information on which active and/or endorsed policies the user has covering the corresponding asset (e.g., a personal liability umbrella policy). In certain embodiments, the coverage indicators 406 may include active or endorsed and deactivated or unendorsed policies, and active or endorsed and deactivated or unendorsed policies have differing indicators (e.g., differing colors or differing shapes). Additionally, in some instances, the coverage indicators 406 may be selectable on the asset summary page 400 (e.g., via the user interface 106 of the user device 104) to activate, endorse, adjust, modify, deactivate, and/or unendorsed the policies. Accordingly, in some instances, the user may select (or pre-select) to retain various coverages and/or limits that are not required when moving to a new state that does not require those coverages and/or turn off non-required coverages they no longer desire.

The asset summary page 400 further includes a context state indicator 408 reflecting context information associated with the asset. For instance, as shown in FIG. 4, the context state indicator 408 may indicate a location that the asset is located in and a duration that the asset has been located in that location. In some other instances, the context state indicator 408 may include various additional or alternative context information associated with the asset, such as any of the various context information described herein.

The asset summary page 400 further includes a context-based notification 410 providing a notification to the user regarding a context-based service plan modification. For instance, as shown in FIG. 4, the context-based notification 410 may notify the user that the user may keep the asset in its current location for a predetermined amount of time (e.g., fifty nine more days) without changes to their policy, but that, if the asset is maintained in its current location for longer than the predetermined amount of time, the user will be required to modify their policy (e.g., to stay in compliance with local regulations). In various embodiments, the context-based notification 410 may provide a notification to the user regarding one or more of a required, an optional, and/or a recommended service plan modification based upon the context information received by the protection service management system 102, in accordance with any of the various scenarios described herein.

In some embodiments, the context-based notification 410 may additionally be selectable on the asset summary page 400 to allow the user to obtain additional information associated with the proposed service plan modification. For instance, in the exemplary notification shown in FIG. 4, the user is notified that, if the user spends fifty-nine more days in California, their policy will need to be adjusted. However, upon clicking on or otherwise interacting with the context-based notification 410, the user may be presented with various additional information, such as an explanation of the specific policy changes that will be needed and any associated premium cost modifications.

As such, the user can decide whether they are comfortable with the potential policy changes or if they would prefer to move to a state where the policy changes are not required. In some implementations, this may allow the user to be notified where less expensive and/or less extensive coverage may be sufficient in view of changes in the context associated with the user and/or may allow the user to initiate more robust coverage where it may be beneficial in view of changing circumstances.

The service plan summary page 500 shown in FIG. 5 depicts a user's historical service plan summary, showing various asset policies 502 provided by the provider associated with the protection service management system 102 over time covering various assets of the user. As depicted, the user's service plan may include multiple policies covering a variety of assets in different service regions or jurisdictions (e.g., different states). Further, because the service plan is tied to or otherwise linked to the user via the user nomad code (e.g., within the user database 114), as opposed to being tied to a physical address, the service plan may be maintained even when the user has no primary physical address.

In some embodiments, each of the asset policies 502 may be selectable on the service plan summary page 500 to view a corresponding asset summary page (e.g., similar to the asset summary page 400) to allow the user to selectively activate, endorse, modify, adjust, deactivate, unendorsed, and/or otherwise interact with or modify the corresponding policies associated with the asset. For instance, service plans may be modified or adjusted via slidable icons, voice bots, or other input/output devices. In some instances, the user may additionally be allowed to selectively add additional assets to their policies and/or obtain policies or endorsements for coverage of assets that the user regularly uses, but does not own (e.g., via one of the asset summary

### Exemplary Dynamic Service Plan Modification Use Cases

In various embodiments, the dynamic context-based service plan modifications described herein may be utilized to enable dynamic billing capabilities. For example, because the service plan modifications described herein may be determined and automatically initiated based upon usage, location, user pre-approval (such as based on their current location and/or travel plans) and other context information associated with the asset, the automated service plan modifications result in the automatic adjustment, pre-approved user adjustment, or real-time user adjustment of policy coverages and corresponding premiums. Accordingly, the user ultimately only has to pay for what they use or need and/or what is recommended for the areas they are actively located in (e.g., as opposed to potentially paying for duplicative or otherwise unnecessary protection in an area where the coverage is either not required or not recommended).

For instance, if the user has coverage for a vehicle, the computer systems and computer-implemented methods described herein may automatically adjust the service plan, the associated polices, and/or the premiums based upon the frequency of use of the vehicle, risk associated with locations (e.g., garage locations) in which the vehicle is parked, a number of different overnight locations in which the vehicle is stored, whether the vehicle is stored for an extended period of time, whether the policy is suspended or activated by the user, a total number of miles driven during a given coverage period, and/or the time of day in which the vehicle is typically driven, etc. In some instances, the computer systems and computer-implemented methods described herein may automatically and/or with user pre-approval activate, adjust, modify, and/or deactivate various policies, endorsements, and/or other types of coverage in real-time or near real-time based upon whether an asset is being actively used (e.g., actively driving a van/RV versus it being parked, in storage, or in a shop), which may be monitored using user input, telematics information, and/or any other information obtained by the protection service management system 102 described herein.

Similarly, if the user has a renter's and/or contents coverage policy for various tangible assets (e.g., computers, electronics, bikes), the computer systems and computer-implemented methods herein may automatically adjust the service plan, the associated policies, and/or the premiums based upon whether the user is living and/or sleeping in their RV, at a friend's house, in a tent, etc., which may be indicated to the protection service management system 102 by the user via the user device 104. Additionally, if a user has commercial liability insurance for a business they run out of their vehicle (e.g., a food truck), the user could selectively drop, suspend, or otherwise modify or adjust the coverage while using the vehicle recreationally.

As one example, the computer systems and computer-implemented methods described herein may allow for or otherwise provide a usage-based insurance policy that includes usage-based coverage on an RV and personal belongings stored within the RV while a user is traveling for an extended period of time (e.g., during the summer months). In this example, the user may provide an indication (e.g., input via the user device 104) that they intend to travel to various locations during a particular period of time, and the system may automatically prompt the user as the user travels (e.g., by detecting their location via GPS data pulled from the user device 104) to adjust and/or modify the coverage based on how and where the RV is being used.

As another example, the usage-based insurance policy could include usage-based coverage that automatically prompts the user to modify coverage from a vehicle from comprehensive coverage to collision coverage (or vice versa) based on whether the vehicle is in use or stored for a longer period of time (e.g., in a parking garage). For example, in some instances, the system may automatically prompt the user if it is determined that the user has entered a parking garage (e.g., by detecting their location via GPS data pulled from the user device 104) asking whether the user is planning to park their covered vehicle for an extended period of time. If the user provides an affirmative answer (e.g., input via the user device 104), the system may then automatically prompt the user to adjust or modify their coverage accordingly.

In certain embodiments, the computer systems and computer-implemented methods described herein may be configured to determine proposed service plan modifications based upon various third-party information that is relevant to the user. For example, the protection service management system 102 may receive a travel itinerary from the user (e.g., input via the user device 104). The protection service management system 102 may then communicate with one or more third-party systems (e.g., a Bureau of Land Management or weather computer system) to determine whether there is a chance that the user's travel plans will be impacted and, if so, offer the user displacement and/or alternative arrangement insurance. For instance, if there is a wildfire risk in a given area that the user intends to stay in, the protection service management system 102 may provide a notification to the user prompting the user to select whether they would like to add displacement and/or alternative arrangement insurance for their trip.

Similarly, if the user owns a business that may be affected by external information, the computer systems and computer-implemented methods described herein may be configured to offer appropriate coverages based upon received information from third-party systems. For instance, if the user owns a farm and the protection service management system 102 determines (e.g., based upon information obtained from a weather computer system) that the user's farm has received or will receive little rain, the protection service management system 102 may provide a notification to the user prompting the user to select whether they would like to add crop insurance to their service plan.

Accordingly, the computer systems and computer-implemented methods described herein beneficially provide dynamic context-based service modifications that may be performed in real-time or near real-time, thereby allowing for usage-based or on-demand service premiums (e.g., usage-based or on-demand insurance premiums) that automatically adjust (e.g., upon user approval) to what the user actually needs throughout a service period.

In various embodiments, when signing up for or otherwise approving or allowing the dynamic context-based service modifications described herein, a notification or user interface may be provided to the user (e.g., via the user interface 106 of the user device 104) indicating that the minimum coverages for the user's current temporary residence will apply for the duration they consider that region (e.g., state) to be their residence and as verified by geolocation/telematics. The provider of the protection service management system 102 may then apply rating factors associated with the user for these coverages for that state for the corresponding amount of time (e.g., the duration that the user and/or relevant asset remains in the state).

In some instances, the policy or policies may have a base rate that is retroactively adjusted/audited by the provider of the protection service management system 102 at the end of the corresponding policy term or service period (e.g., one month, six months, a year). That is, the provider may charge the user an estimated monthly fee, and then either charge or reimburse the user (or apply a debit/credit to next month's bill) based upon the context information and the automated service plan modifications made throughout the policy term or service period.

In certain embodiments, to avoid any potential lapses or cancellations of the user's service plan (and thereby ensure that the user's loyalty credits remain intact), the protection service management system 102 may provide various cancellation prevention options and/or incentives. For example, in some instances, when the user is traveling (e.g., does not have a permanent physical address), the provider may provide the user with various low-cost policy options that allow for the customer to retain the overall service plan. Further, in some instances, the provider may allow for the user to utilize an autopay feature that enables to miss a payment without losing their insurance. Specifically, the user may create a life policy and/or an investment account with the provider that can be used as collateral for their payments, such that missed payments do not lose the user their longevity credits with the provider. Additionally, the provider may provide long-term policy retention premiums that may be purchase by the user to retain their longevity credits (e.g., in the case of long international travel and/or multi-year stays overseas) if they eventually move back to the country and/or return to a less nomadic lifestyle.

In various embodiments, the user may be able to obtain various estimated coverage and premium information associated with an upcoming travel period. For instance, the user may provide (e.g., via the user interface 106 of the user device 104) one or more potential travel options (e.g., destinations, times, and durations) to the protection service management system 102 (e.g., via the network 120), as well as what assets might be brought along during the potential travel period. The protection service management system 102 may then determine any required, optional, and/or recommended service plan modifications that would apply to the one or more potential travel options based upon the provided travel options and any relevant context information. The protection service management system 102 may then provide a coverage and premium cost comparison between the different potential travel options for the user. In some instances, the determined coverages and/or premiums for different travel options may be saved for future reference by the user without activating those coverages and/or premiums.

In certain embodiments, in addition or alternative to the estimated coverage and premium information associated with the user's upcoming travel period, the user may be able to obtain various travel assistance information associated with their current location and/or an upcoming travel period. For instances, the protection service management system 102 may be configured to pull information from a variety of third parties (e.g., associated with the third-party systems 112) via the network 120 to identify a variety of relevant information to provide to the user. For example, the protection service management system 102 (e.g., the data compiler 210, the recommendation generator 212, the notification generator 214) may be able to pull information, generate recommendations, and/or provide various other notifications to the user pertaining to a variety of events and/or other information going on in their area and/or in any expected travel locations.

For example, in some instances, the protection service management system 102 may generate recommendations and/or provide notifications to the user (e.g., via the user device 104) regarding local activities, local points of interest, opportunities for the user to mix and/or integrate themselves with the local culture, local health and/or mental health service providers, local Wi-Fi access locations, local third-party services, local volunteer opportunities, local sites and landmarks, etc. In some instances, the protection service management system 102 may be configured to personalize the recommendations and/or information provided to the user based on various user preferences and/or other user goals (e.g., provided via user input by the user using the user device 104).

### Exemplary Machine Learning and Generative AI

As discussed elsewhere, some embodiments may utilize machine learning, generative artificial intelligence, or other advanced computing techniques. As such, in some embodiments, generative artificial intelligence (AI) models (also referred to as generative machine learning (ML) models) and/or other AI/ML models discussed herein may be implemented via and/or coupled to one or more voice bots and/or chatbots that may be configured to utilize artificial intelligence and/or machine learning techniques. For instance, the voice and/or chatbot may be a ChatGPT chatbot, a ChatGPT-based bot, and/or another generative AI tool (e.g., generative AI bot, API, model, etc.). The voice and/or chatbot may employ supervised, unsupervised, and/or semi-supervised machine learning techniques, which may be followed by, and/or used in conjunction with, reinforced and/or reinforcement learning techniques. The voice bot, chatbot, ChatGPT bot, ChatGPT-based bot, generative AI tool (e.g., generative AI bot, API, model, etc.), and/or other such generative model may generate audible or verbal output, text or textual output, visual or graphical output, output for use with speakers and/or display screens of a mobile computing device, and/or other types of output for user and/or other computer or bot consumption.

Noted above, in some embodiments, a chatbot or other computing device may be configured to implement machine learning, such that the computing device “learns” to analyze, organize, and/or process data without being explicitly programmed. Machine learning and/or artificial intelligence may be implemented through machine learning methods and algorithms. In one exemplary embodiment, a machine learning module may be configured to implement the ML methods and algorithms.

As used herein, a voice bot, chatbot, ChatGPT bot, ChatGPT-based bot, generative AI tool (e.g., generative AI bot, API, model, etc.), and/or other such generative model (referred to broadly as “chatbot” herein) may refer to a specialized system for implementing, training, utilizing, and/or otherwise providing an AI or ML model to a user for dialogue interaction (e.g., “chatting”). Depending on the embodiment, the chatbot may utilize and/or be trained according to language models, such as natural language processing (NLP) models and/or large language models (LLMs). Similarly, the chatbot may utilize and/or be trained according to generative adversarial network (GAN) techniques, such as the machine learning techniques, algorithms, and systems described in more detail below.

The chatbot may receive inputs from a user via text input, spoken input, gesture input, etc. The chatbot may then use AI and/or ML techniques as described herein to process and analyze the input before determining an output and displaying the output to the user. Depending on the embodiment, the output may be in a same or different form than the input (e.g., spoken, text, gestures, etc.), may include images, and/or may otherwise communicate the output to the user in an overarching dialogue format.

In various embodiments, at least one of a plurality of ML methods and algorithms may be applied to implement and/or train the chatbot, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, a chatbot ML module employs supervised learning, which involves identifying patterns in existing data to make predictions about subsequently received data. Specifically, the chatbot ML module may be “trained” using training data, which includes example inputs and associated example outputs. Based upon the training data, the chatbot ML module may generate a predictive function which maps outputs to inputs and may utilize the predictive function to generate ML outputs based upon data inputs. The exemplary inputs and exemplary outputs of the training data may include any of the data inputs or ML outputs described above. In the exemplary embodiment, a processing element may be trained by providing it with a large sample of data with known characteristics or features.

In another embodiment, the chatbot ML module may employ unsupervised learning, which involves finding meaningful relationships in unorganized data. Unlike supervised learning, unsupervised learning does not involve user-initiated training based upon example inputs with associated outputs. Rather, in unsupervised learning, the chatbot ML module may organize unlabeled data according to a relationship determined by at least one ML method/algorithm employed by the chatbot ML module. Unorganized data may include any combination of data inputs and/or ML outputs as described above.

In yet another embodiment, the chatbot ML module may employ semi-supervised learning, which involves using thousands of individual supervised machine learning iterations to generate a structure across the multiple inputs and outputs. In this way, the chatbot ML module may be able to find meaningful relationships in the data, similar to unsupervised learning, while leveraging known characteristics or features in the data to make predictions via a ML output.

In yet another embodiment, the chatbot ML module may employ reinforcement learning, which involves optimizing outputs based upon feedback from a reward signal. Specifically, the chatbot ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In certain embodiments, the chatbot ML module may be used in conjunction with the machine vision, image recognition, object identification, AR glasses, VR headsets, wearables, smart devices, smart glasses, smart rings, laptops, voice bots, chatbots, other input/output devices, and/or other image processing techniques discussed below. Additionally or alternatively, in some embodiments, the chatbot ML module may be configured and/or trained to implement one or more aspects of the machine vision, image recognition, objection identification, and/or other image processing techniques discussed below.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied, or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In some embodiments, a computer program is provided, and the program is embodied on a computer readable medium. In some embodiments, the system is executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The construction and arrangement of the systems and methods as shown in the various example embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied, and the nature or number of discrete elements or positions can be altered or varied. Accordingly, all such modifications are intended to be included within the scope of the present disclosure. The order or sequence of any process or method operations, actions, or functionality may be varied or re-sequenced according to alternative embodiments. Other substitutions, modifications, changes, and omissions can be made in the design, operating conditions, and arrangement of the example embodiments without departing from the scope of the present disclosure.

As used herein, an element or operation recited in the singular and proceeded with the word “a” or “an” should be understood as not excluding plural elements or operations, unless such exclusion is explicitly recited. Furthermore, references to “exemplary embodiment,” “one embodiment,” or “some embodiment” of the present disclosure are not intended to be interpreted as excluding the existence of additional embodiments that also incorporate the recited features.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The patent claims at the end of this document are not intended to be construed under 35 U.S.C. § 112(f) unless traditional means-plus-function language is expressly recited, such as “means for” or “step for” language being expressly recited in the claim(s).

Although the Figures show a specific order of method operations, actions, or functionality, the order of such may differ from what is depicted. Also, two or more operations, actions, or functionalities may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection operations or actions, processing operations or actions, comparison operations or actions, and decision operations or actions.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The term “coupled” and variations thereof, as used herein, means the joining of two members directly or indirectly to one another. Such joining may be stationary (e.g., permanent, or fixed) or moveable (e.g., removable, or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

In various implementations, the functionality and operations described herein may be performed on one processor or in a combination of two or more processors. For example, in some implementations, the various operations could be performed in a central server or set of central servers configured to receive data from one or more devices (e.g., edge computing devices/controllers) and perform the operations. In some implementations, the operations may be performed by one or more local controllers or computing devices (e.g., edge devices), such as controllers dedicated to and/or located within a particular industrial environment or portion of an industrial environment. Additionally or alternatively, the operations may be performed by a combination of one or more central or offsite computing devices/servers and one or more local controllers/computing devices. All such implementations are contemplated within the scope of the present disclosure.

Further, unless otherwise indicated, when the present disclosure refers to one or more computer-readable storage media and/or one or more controllers, such computer-readable storage media and/or one or more controllers may be implemented as one or more central servers, one or more local controllers or computing devices (e.g., edge devices), any combination thereof, or any other combination of storage media and/or controllers regardless of the location of such devices.

What is claimed is:

1. A protection service management computer system comprising:
one or more memory devices having instructions stored thereon that, when executed by one or more processors, cause the one or more processors to perform operations comprising:
detecting a change in context information associated with a user having a protection service plan that protects an asset of the user, the context information being automatically determined without the user being required to manually provide the context information and including location information associated with the asset of the user;
determining a modification of the protection service plan of the user based upon the change in the context information;
transmitting a prompt to a user device associated with the user, the prompt requesting approval of the modification; and
initiating the modification upon receiving approval of the modification via the user device.

2. The protection service management computer system of claim 1, wherein the location information indicates that the asset of the user has moved from a first service region to a second service region, the first service region and the second service region having one or more of different service requirements, different service availabilities, or different recommended services associated with the asset.

3. The protection service management computer system of claim 2, wherein the prompt is automatically transmitted in response to determining that the location information indicates that the asset has moved from the first service region to the second service region and that the first service region and the second service region have the one or more of the different service requirements, the different service availabilities, or the different recommended services associated with the asset.

4. The protection service management computer system of claim 3, wherein determining that the location information indicates that the asset has moved from the first service region to the second service region includes determining that the asset has remained in the second service region for a predetermined amount of time.

5. The protection service management computer system of claim 3, wherein initiating the modification of the protection service plan includes adding or removing at least one of a required service, an optional service, or a recommended service for the asset to or from the protection service plan.

6. The protection service management computer system of claim 1, wherein the prompt further includes an estimated cost of the modification.

7. The protection service management computer system of claim 1, wherein the context information includes telematics information received from a device associated with the asset and indicative of usage of the asset, and wherein determining the modification is performed based upon the location information and the telematics information.

8. A computer-implemented method for performing dynamic context-based service plan modifications, the computer-implemented method comprising:
detecting, using one or more processors and one or more computer-readable storage media having instructions stored thereon executable by the one or more processors, a change in context information associated with a user having a protection service plan that protects an asset, the context information including location information associated with the asset of the user;
determining, using the one or more processors, a proposed modification of the protection service plan of the user in response to detecting the change in the context information and without the user being required to request the proposed modification of the protection service plan;
providing, using the one or more processors, a prompt to a user device of the user in response to determining the proposed modification, the prompt indicating the proposed modification of the protection service plan and requesting approval; and
initiating, using the one or more processors, the proposed modification in response to receiving an indication of approval from the user device of the user.

9. The computer-implemented method of claim 8, wherein the location information indicates that the asset of the user has moved from a first service region to a second service region, the first service region and the second service region having one or more of different service requirements, different service availabilities, or different recommended services associated with the asset.

10. The computer-implemented method of claim 8, wherein the asset is an additional asset to be added to the service plan, and determining the proposed modification of the service plan includes determining at least one of a required service, an optional service, or a recommended service for the asset based upon the location information.

11. The computer-implemented method of claim 8, wherein the asset is one of a vehicle, a property, or a business.

12. The computer-implemented method of claim 8, wherein the protection service plan includes a plurality of services for a plurality of assets in a plurality of service regions having one or more of different service requirements, different service availabilities, or different recommended services associated with the asset.

13. The computer-implemented method of claim 8, wherein the protection service plan is linked to the user within a database using a user index code that is not associated with a physical address.

14. The computer-implemented method of claim 8, wherein the location information is one of global positioning system (GPS) data pulled from at least one of the user device of the user or another device associated with the asset or a received user input indicating one or more of a previous location, a current location, or a future location of the asset.

15. The computer-implemented method of claim 8, further comprising:
receiving a service cost estimate request including a planned location of the asset and a planned amount of time for the asset to be in the planned location;
determining one or more of a required service or a recommended service for the asset based upon the planned location and the planned amount of time;
determine a cost of the one or more of the required service or the recommended service; and
provide the cost to the user.

16. A non-transitory computer-readable medium comprising instructions stored thereon that, when executed by one or more processors, cause the one or more processors to perform operations comprising:
detecting a change in context information associated with a user having a nomadic protection service plan, the nomadic protection service plan protecting an asset of the user as the asset is moved between different service regions having one or more of different service requirements, different service availabilities, or different recommended services associated with the asset, the context information including location information associated with the asset of the user;
determining a modification of the nomadic protection service plan of the user based upon the change in the context information indicating that the asset has moved from a first service region to a second service region;
transmitting a prompt to a user device associated with the user, the prompt requesting approval of the modification; and
initiating the modification of the nomadic protection service plan upon receiving approval of the modification via the user device.

17. The non-transitory computer-readable medium of claim 16, wherein the prompt is automatically transmitted in response to determining that the location information indicates that the asset has moved from the first service region to the second service region and that the first service region and the second service region have one or more of the different service requirements, the different service availabilities, or the different recommended services associated with the asset.

18. The non-transitory computer-readable medium of claim 16, wherein the prompt further includes an estimated cost of the modification.

19. The non-transitory computer-readable medium of claim 16, wherein determining the modification includes determining that the context information indicates that the asset has remained in the second service region for a predetermined amount of time.

20. The non-transitory computer-readable medium of claim 16, wherein initiating the modification of the nomadic protection service plan includes adding or removing at least one of a required service, an optional service, or a recommended service for the asset to or from the nomadic protection service plan.
